(19) United States
(12) Patent Application Publication
(10) Pub. No.: US 2024/0119710 A1
(43) Pub. Date: Apr. 11, 2024

(54) METHODS, SYSTEMS, APPARATUS, AND ARTICLES OF MANUFACTURE TO AUGMENT TRAINING DATA BASED ON SYNTHETIC IMAGES

(71) Applicant: Intel Corporation, Santa Clara, CA (US)

(72) Inventors: Anmol Bhasin, SAS Nagar (IN); Shekar Ramachandran, Bengaluru (IN); Rudra Nath Palit, Kolkata (IN); Rupali Agrahari, Sultanpur (IN); Sai Pramod Gadam, Bengaluru (IN)

(21) Appl. No.: 18/542,133

(22) Filed: Dec. 15, 2023

(51) Int. Cl. G06V 10/774; G06V 10/776; G06V 10/82; G06V 20/40; G06V 40/16

(52) U.S. Cl. CPC G06V 10/774; G06V 10/776; G06V 10/82; G06V 20/40; G06V 40/16

(57) ABSTRACT

Methods, systems, apparatus, and articles of manufacture to augment training data based on synthetic images are disclosed. An example apparatus disclosed herein includes programmable circuitry to generate, with one or more first layers of a generative adversarial network (GAN), a latent representation corresponding to a first image representative of a first racial domain, generate, with one or more second layers of the GAN, a second image based on the latent representation, the second image corresponding to a second racial domain different from the first racial domain, and augment a training dataset based on the second image.

### FIELD OF THE DISCLOSURE

This disclosure relates generally to image processing and, more particularly, to methods, systems, apparatus, and articles of manufacture to augment training data based on synthetic images.

### BACKGROUND

Deepfakes refer to manipulated media content (e.g., images and/or videos) created using deep learning techniques. Deepfake detection algorithms may be trained to distinguish between real and synthetic images. Such deepfake detection algorithms are commonly trained based on training datasets, where the training datasets may include images representative of human faces across multiple different racial and/or ethnic backgrounds.

### BRIEF DESCRIPTION OF THE DRAWINGS

FIG. 1 illustrates an example generator network of an example hybrid generative adversarial network (GAN) for generating synthetic images in accordance with teachings of this disclosure.

FIG. 2 illustrates an example discriminator network for classifying images in accordance with teachings of this disclosure.

FIG. 3 is a block diagram of example data augmentation circuitry that implements the example generator network of FIG. 1 and/or the example discriminator network of FIG. 2.

FIG. 4 is a flowchart representative of example machine readable instructions and/or example operations that may be executed, instantiated, and/or performed by example programmable circuitry to implement the example generator network of FIG. 1 using the data augmentation circuitry of FIG. 3.

FIG. 5 is a flowchart representative of example machine readable instructions and/or example operations that may be executed, instantiated, and/or performed by example programmable circuitry to implement the example discriminator network of FIG. 2 using the data augmentation circuitry of FIG. 3.

FIG. 6 is a block diagram of an example processing platform including programmable circuitry structured to execute, instantiate, and/or perform the example machine readable instructions and/or perform the example operations of FIGS. 4 and/or 5 to implement the data augmentation circuitry of FIG. 3.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 4 and/or 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Deep learning techniques have been developed to manipulate media content. Deepfakes, which refer to manipulated media content created using deep learning techniques, may be difficult to detect based on human observation alone. As such, deepfake detection algorithms (e.g., deepfake detection models, machine learning models, etc.) have been developed to distinguish between real (e.g., genuine, unaltered) images and manipulated (e.g., synthetic, altered) images. Typically, such deepfake detection algorithms are trained using training datasets including images of human faces from multiple different racial and/or ethnic backgrounds. For example, the deepfake detection algorithms can be trained to identify patterns in the training dataset to distinguish between genuine and manipulated content.

Some training datasets include a disproportionate and/or insufficient number of images for one or more racial and/or ethnic domains. For instance, a count and/or a proportion (e.g., percentage) of images for one(s) of the racial domains may be less than a threshold (e.g., a threshold count and/or a threshold percentage). In some instances, when one or more racial domains are disproportionately represented (e.g., underrepresented or overrepresented) in the training dataset, the resulting deepfake detection algorithm may be biased and/or inaccurate when trained based on the training dataset.

Examples disclosed herein implement an example generative adversarial network (GAN) to generate and/or output one or more example synthetic images (e.g., computer-generated images) representative of respective different racial domains. Some examples disclosed herein implement a hybrid GAN architecture based on Style transfer via Texture-synthesis and Arbitrary style Representation (STAR) techniques and a Style GAN. In some examples, the STAR component enables transfer of style (e.g., racial features and/or characteristics) from one or more reference images to an example input image while maintaining underlying content from the input image. Further, the Style GAN component enables generation of synthetic images with diverse racial attributes. In examples disclosed herein, the hybrid GAN includes an example generator network and an example discriminator network that may be trained in an adversarial manner.

In some examples, one or more first example layers of the hybrid GAN are used to generate a latent representation corresponding to a first example image (e.g., an input image). In some examples, the first image is representative of a human face with first characteristics (e.g., first facial features and/or first attributes) corresponding to a first example racial domain. Further, one or more second example layers of the hybrid GAN are used to generate a second example image (e.g., a synthetic image) based on the latent representation. In some examples, the second image is representative of the human face with second characteristics (e.g., second facial features and/or second attributes) corresponding to a second racial domain different from the first racial domain. In some examples, the first image and/or the second image can be provided to an example discriminator (e.g., a discriminator network) of the hybrid GAN. In some such examples, the discriminator generates and/or outputs one or more example labels (e.g., authenticity classification label(s) and/or domain classification label(s)) for corresponding one(s) of the images. In some examples, the label(s) can be used for training (e.g., adjusting weights of) one or more layers of the hybrid GAN.

In some examples, the synthetic image(s) generated by the hybrid GAN can be used to augment a training dataset utilized for training an example deepfake detection model. For example, the hybrid GAN disclosed herein can be used to generate the synthetic image(s) for one or more racial domains having insufficient and/or disproportionate representation in the training dataset. By augmenting the training dataset with the synthetic image(s), examples disclosed herein may reduce bias and/or improve accuracy of the deepfake detection algorithm when trained based on the training dataset.

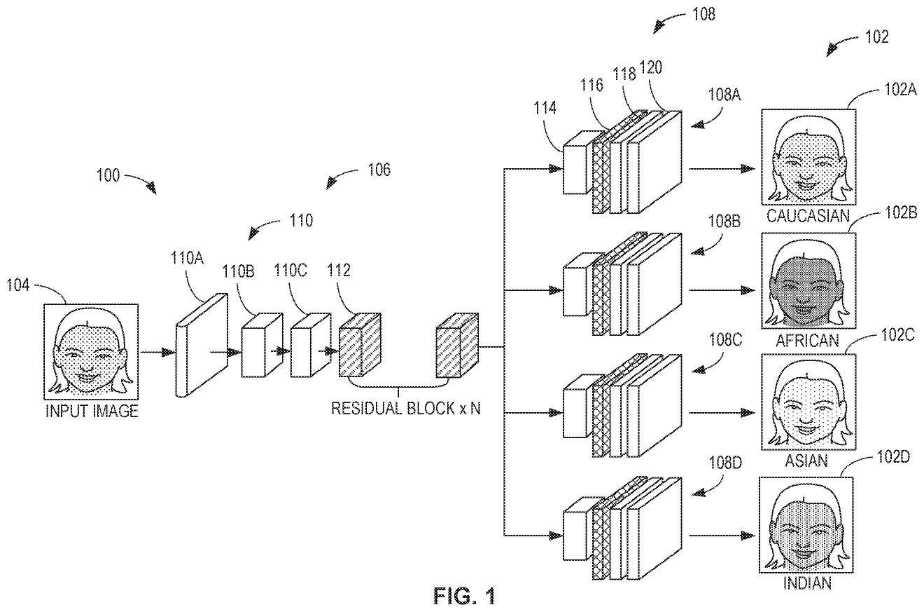

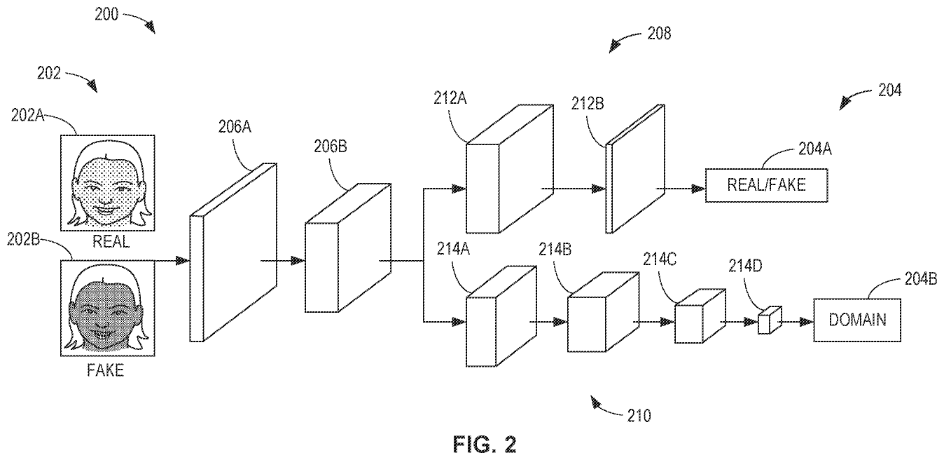

FIG. 1 illustrates an example generator network 100 of an example hybrid generative adversarial network (GAN) for generating synthetic images in accordance with teachings of this disclosure. In particular, the hybrid GAN includes the example generator network 100 of FIG. 1 and the example discriminator network 200 of FIG. 2. In the illustrated example of FIG. 1, the generator network 100 is trained to generate a plurality of example synthetic images 102 based on an example input image 104 representative of a human face. In this example, the synthetic images 102 correspond to respective different domains (e.g., racial and/or ethnic domains). For example, a first example synthetic image 102A is representative of a first example domain (e.g., Caucasian), a second example synthetic image 102B is representative of a second example domain (e.g., African), a third example synthetic image 102C is representative of a third example domain (e.g., Asian), and a fourth example synthetic image 102D is representative of a fourth example domain (e.g., Indian). Further, the human face represented in the input image 104 corresponds to a fifth example racial domain different from the first racial domain, the second racial domain, the third racial domain, and/or the fourth racial domain of the synthetic images 102. While four of the synthetic images 102 are shown in FIG. 1, a different number of the synthetic images 102 may be generated instead. Further, one or more different domains can be used for the synthetic images 102 in addition to or instead of the domains included in FIG. 1.

In the example of FIG. 1, the generator network 100 is based on a Style GAN architecture implementing STAR techniques. In particular, the generator network 100 includes an example encoder (e.g., an encoder network, encoder layers) 106 providing input to multiple example decoders (e.g., decoder networks, decoder layers) 108 corresponding to respective different racial domains. In this example, the encoder 106 includes a sequence of encoder layers (e.g., two-dimensional (2-D) convolutional layers) 110 including a first example convolutional layer 110A, a second example convolutional layer 110B, and a third example convolutional layer 110C.

In some examples, the encoder 106 accesses the input image 104 and extracts example features therefrom to generate an example latent representation (e.g., a feature map) of the input image 104. The features can represent, for example, a facial feature to which one or more pixels of the input image 104 correspond, whether the pixel(s) correspond to a surface or an edge of the facial feature, etc. In some examples, new features are extracted at subsequent one(s) of the encoder layers 110, and the features are stored in corresponding new channels generated for the latent representation of the input image 104. As a result, a feature dimensionality of the latent representation (e.g., the number of channels used to represent per-pixel information and/or features) increases across the encoder layers 110. In some examples, at the subsequent one(s) of the encoder layers 110, the encoder 106 clusters and/or groups regions of the input image 104 based on the extracted features, such that the spatial resolution of the latent representation is reduced across the encoder layers 110. While three of the convolutional layers 110A, 110B, 110C are used in the example of FIG. 1, a different number of convolutional layers may be used instead.

In the illustrated example of FIG. 1, the latent representation generated at the convolutional layers 110A, 110B, 110C is provided as input to one or more example residual blocks 112. In some examples, the residual blocks 112 correspond to respective sets of stacked layers (e.g., convolutional layers) having a residual connection (e.g., a skip connection) between an input to the stacked layers and a corresponding output of the stacked layers. Such residual connections are used to perform identity mapping between the inputs and the outputs, where the inputs are added to the corresponding outputs for one(s) of the residual blocks 112. In some examples, the identity mappings and/or residual connections enable information to bypass one(s) of the stacked layers, thus reducing performance degradation that may occur when additional layers are added to the residual blocks 112.

In the illustrated example of FIG. 1, the residual blocks 112 are used to introduce noise (e.g., experimental noise) to the latent representation. In some examples, values for the noise introduced at one(s) of the residual blocks 112 are initially (e.g., prior to training of the generator network 100) selected based on a probability distribution (e.g., a Gaussian distribution). During training, loss values (e.g., error values) are calculated between predicted outputs and actual outputs of the residual blocks 112 at multiple iterations of the training, and the noise values for the residual blocks 112 can be adjusted based on the loss values (e.g., using backpropagation). In the example of FIG. 1, N=9 of the residual blocks 112 are used. In some examples, a different number N of the residual blocks 112 may be used instead. In some examples, the residual blocks 112 are used to implement the STAR component of the hybrid GAN. For example, residual blocks 112 may be trained based on one or more reference images to enable transfer of style (e.g., racial attributes and/or characteristics) from the reference image(s) to the input image 104. In some examples, the transfer of style results from the introduction of noise into the latent representation at the residual blocks 112.

In the illustrated example of FIG. 1, an output of the residual blocks 112 is provided to one or more of the decoders 108, where the decoders 108 include a first example decoder 108A corresponding to the first domain, a second example decoder 108B corresponding to the second domain, a third example decoder 108C corresponding to the third domain, and a fourth example decoder 108D corresponding to the fourth domain In this example, a number and/or arrangement of layers is the same for multiple one(s) of the decoders 108. For example, one(s) of the decoders 108 include a corresponding fourth example convolutional layer (e.g., a fourth 2-D convolutional layer) 114 followed by an example convolutional inverse layer 116, a fifth example convolutional layer (e.g., a fifth 2-D convolutional layer) 118, and a sixth example convolutional layer (e.g., a sixth 2-D convolutional layer) 120. In some examples, a different number and/or arrangement of the layers 114, 116, 118, 120 can be used for one(s) of the decoders 108. In this example, although the number and/or arrangement of the layers 114, 116, 118, 120 is the same across multiple ones of the decoders 108, weights of the layers 114, 116, 118, 120 are different across different ones of the decoders 108. In particular, the weights are selected and/or adjusted such that the decoders 108 output the synthetic images 102 corresponding to the respective domains of the decoders 108.

In this example, to generate one of the synthetic images 102 (e.g., the first synthetic image 102A), the output of the residual blocks 112 is provided to the fourth convolutional layer 114 of the first decoder 108A. The convolutional inverse layer 116 is trained to modify and/or convert the output of the fourth convolutional layer 114 to a dimensionality of the input image 104. Further, the fifth and sixth convolutional layers 118, 120 of the first decoder 108A are trained to transfer style and/or racial characteristics from reference images (e.g., corresponding to the first domain) to the modified output of the convolutional inverse layer 116. As a result, the sixth convolutional layer 120 outputs the first synthetic image 102A, where the first synthetic image 102A includes content that is modified relative to the input image 104. In particular, the synthetic image 102A corresponds to the human face represented in the input image 104, but with modified facial features and/or attributes corresponding to the first domain Additionally or alternatively, in some examples, the output of the residual blocks 112 can be provided to at least one of the second decoder 108B, the third decoder 108C, or the fourth decoder 108D to generate and/or output the corresponding synthetic images 102B, 102C, 102D for the respective different domains. In some examples, ones of the decoders 108 may be executed at the same time (e.g., in parallel) or at different times (e.g., in series).

In the illustrated example of FIG. 1, one(s) of the generated synthetic images 102 can be used to augment a training dataset. For example, the synthetic image(s) 102 can be stored in memory (e.g., computer memory) in association with one or more images included in the training dataset. In some examples, the training dataset can include real and/or synthetic images representative of human faces corresponding to one or more racial domains. In some examples, the training dataset can be used for training a deepfake detection algorithm. In some examples, the training dataset may include a disproportionate number of images for one(s) of the racial domains and/or may lack sufficient images for one(s) of the racial domains (e.g., a number of the images corresponding to the one(s) of the racial domains is less than a threshold). In some examples, augmenting the training dataset with one(s) of the synthetic images 102 may increase representation of one or more racial domains in the training dataset and, thus, may mitigate racial bias in the resulting deepfake detection algorithm.

FIG. 2 illustrates an example discriminator network 200 for classifying images in accordance with teachings of this disclosure. In some examples, the discriminator network 200 is included in the example hybrid GAN including the example generator network 100 of FIG. 1. In other words, some example GANs described herein include both the generator network 100 of FIG. 1 and the discriminator network 200 of FIG. 2. In the illustrated example of FIG. 2, the discriminator network 200 is trained to classify example input images 202 and generate and/or output corresponding example labels 204 based on the classifications. In particular, the labels 204 include a first example label (e.g., an authenticity classification label) 204A indicating whether a corresponding one of the input images 202 is real (e.g., unmodified, ground truth) or synthetic, and a second example label (e.g., a domain classification label) 204B indicating a predicted racial domain for the corresponding one of the input images 202.

In the illustrated example of FIG. 2, the input images 202 include a first example input image 202A (e.g., a real and/or unmodified image) and a second example input image 202B (e.g., a synthetic image). In particular, the first input image 202A corresponds to the input image 104 of FIG. 1, and the second input image 202B corresponds to one of the synthetic images 102 generated by the generator network 100 of FIG. 1. In this example, one or more of the input images 202 are provided as input to a first example encoder layer 206A of the discriminator network 200. In some examples, the first encoder layer 206A and a second encoder layer 206B of the discriminator network 200 are convolutional layers (e.g., 2-D convolutional layers) trained to extract features from the input image(s) 202 and generate an example latent representation of the input image(s) 202. In some examples, a feature dimensionality of the latent representation increases from the first encoder layer 206A to the second encoder layer 206B, while the spatial resolution of the latent representation is reduced from the first encoder layer 206A to the second encoder layer 206B. While two of the encoder layers 206A, 206B are used in the example of FIG. 2, a different number of encoder layers may be used instead.

In the illustrated example of FIG. 2, the latent representation output by the encoder layers 206A, 206B is provided as input to an example authenticity classifier (e.g., an authenticity classification network, authenticity classification layer(s)) 208 and/or an example domain classifier (e.g., a domain classification network, domain classification layer(s)) 210 of the discriminator network 200. In this example, the authenticity classifier 208 includes first and second example convolutional layers (e.g., 2-D convolutional layers) 212A, 212B trained to output the first label 204A based on the latent representation from the encoder layers 206A, 206B. For example, the convolutional layers 212A, 212B of the authenticity classifier 208 determine whether features of the input image(s) 202 represented in the latent representation are indicative of a real image or a synthetic image, and output the first label 204A based on the determination. Further, the domain classifier 210 includes corresponding example convolutional layers 214A, 214B, 214C, 214D trained to output the second label 204B based on the latent representation from the encoder layers 206A, 206B. For example, the convolutional layers 214A, 214B, 214C, 214D detect race-specific attributes of the input image(s) 202 represented in the latent representation, and output the second label 204B indicative of a predicted racial domain for the input image(s) 202. In the example of FIG. 2, the authenticity classifier 208 includes two of the convolutional layers 212A, 212B and the domain classifier 210 includes four of the convolutional layers 214A, 214B, 214C, 214D. In some examples, a different number of convolutional layers can be used for at least one of the authenticity classifier 208 or the domain classifier 210.

In some examples, the first label 204A and/or the second label 204B can be stored in memory in association with the respective one(s) of the input images 202. In some examples, the label(s) 204 output by the discriminator network 200 can be used to train and/or retrain the discriminator network 200 and/or the generator network 100 of FIG. 1. For example, a discrepancy (e.g., a loss value) can be calculated based on the predicted classifications (e.g., corresponding to the first and second labels 204A, 204B) and ground truth classifications (e.g., a ground truth authenticity classification and/or a ground truth domain classification) for respective one(s) of the input images 202. In some examples, weights of one or more layers of the generator network 100 of FIG. 1 and/or the discriminator network 200 of FIG. 2 can be adjusted based on the discrepancy.

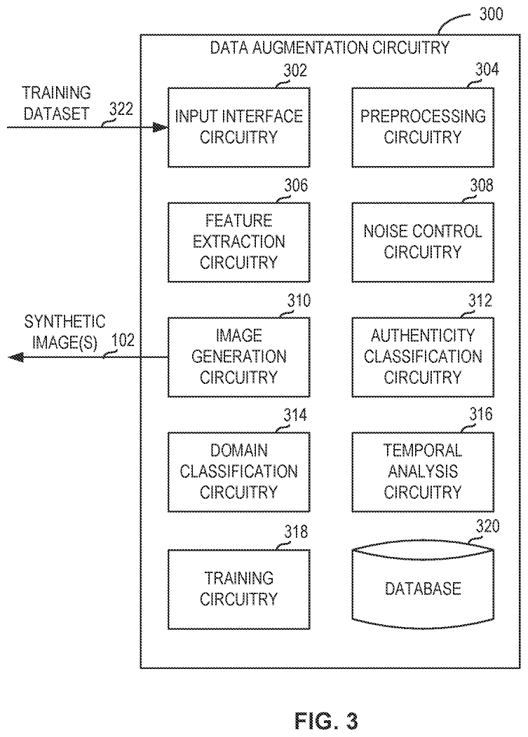

FIG. 3 is a block diagram of example data augmentation circuitry 300 that may implement the example generator network 100 of FIG. 1 and/or the example discriminator network 200 of FIG. 2. The example data augmentation circuitry 300 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the data augmentation circuitry 300 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

In the illustrated example of FIG. 3, the data augmentation circuitry 300 includes example input interface circuitry 302, example preprocessing circuitry 304, example feature extraction circuitry 306, example noise control circuitry 308, example image generation circuitry 310, example authenticity classification circuitry 312, example domain classification circuitry 314, example temporal analysis circuitry 316, example training circuitry 318, and an example database 320.

The example database 320 of FIG. 3 stores data utilized, generated, and/or obtained by the data augmentation circuitry 300. The example database 320 of FIG. 3 is implemented by any memory, storage device and/or storage disc for storing data such as, for example, flash memory, magnetic media, optical media, solid state memory, hard drive(s), thumb drive(s), etc. Furthermore, the data stored in the example database 320 may be in any data format such as, for example, binary data, comma delimited data, tab delimited data, structured query language (SQL) structures, etc. While, in the illustrated example, the example database 320 is illustrated as a single device, the example database 320 and/or any other data storage devices described herein may be implemented by any number and/or type(s) of memories.

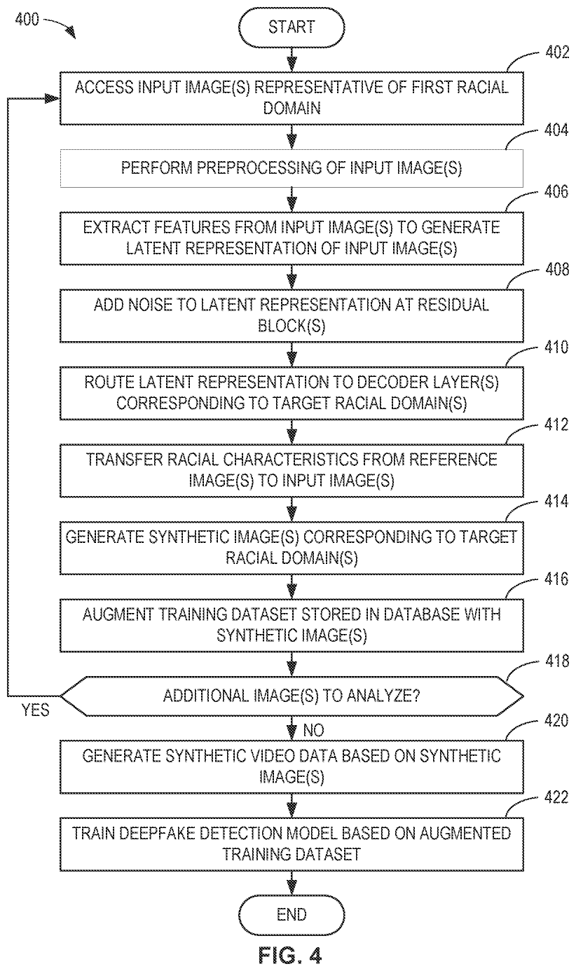

The example input interface circuitry 302 receives, accesses, and/or obtains example input data to be utilized by the data augmentation circuitry 300. For example, the input interface circuitry 302 accesses and/or obtains an example training dataset 322 which may be augmented by the data augmentation circuitry 300 and/or which may be used for training the example generator network 100 of FIG. 1, the example discriminator network 200 of FIG. 2, and/or an example deepfake detection algorithm. In some examples, the training dataset 322 includes one or more images (e.g., ground truth images and/or synthetic images) representative of human faces corresponding to respective racial domains. In some examples, the training dataset 322 includes the example input image 104 of FIG. 1 based on which the example synthetic images 102 of FIG. 1 are to be generated. In some examples, the input interface circuitry 302 provides the training dataset 322 (e.g., including the input image 104) to the database 320 for storage therein. In some examples, the input interface circuitry 302 is instantiated by programmable circuitry executing input interface circuitry instructions and/or configured to perform operations such as those represented by the flowchart(s) of FIGS. 4 and/or 5.

The example preprocessing circuitry 304 processes and/or modifies one(s) of the images included in the training dataset 322. For example, the preprocessing circuitry 304 can divide the training dataset 322 into one or more subsets of images, where the subsets correspond to different racial domains. For example, the preprocessing circuitry 304 can select a first subset including first images corresponding to a first racial domain (e.g., Caucasian), a second subset including second images corresponding to a second racial domain (e.g. African), a third subset including third images corresponding to a third racial domain (e.g., Asian), and a fourth subset including fourth images corresponding to a fourth racial domain (e.g., Indian). In some examples, a number of the subsets and/or the domains corresponding to the subsets may be different. In some examples, the preprocessing circuitry 304 selects a threshold number (e.g., 500, 1000, 5000, etc.) of images from each of the subsets for use in training one or more machine learning models (e.g., the generator network 100 of FIG. 1, the discriminator network 200 of FIG. 2, one or more deepfake detection models, etc.).

In some examples, the preprocessing circuitry 304 performs one or more preprocessing tasks based on the selected ones of the images. For example, the preprocessing circuitry 304 can perform image alignment to align corresponding facial features across ones of the images. In some examples, the preprocessing circuitry 304 can identify and/or remove low quality images (e.g., images that are blurry and/or have a resolution below a threshold resolution) from the selected ones of the images. In some examples, the preprocessing circuitry 304 can apply one or more example normalization techniques to the selected ones of the images, such as resizing the images to a target resolution and/or, when the images include one or more video frames of a video, converting the video frames to a target format. In some examples, the preprocessing circuitry 304 performs one or more example augmentation techniques to the selected ones of the images, including rotating, scaling, and/or flipping the images and/or portions thereof. In some examples, the preprocessing circuitry 304 provides processed one(s) of the images to the database 320 for storage therein. In some examples, the preprocessing circuitry 304 is instantiated by programmable circuitry executing preprocessing circuitry instructions and/or configured to perform operations such as those represented by the flowchart(s) of FIGS. 4 and/or 5.

In the illustrated example of FIG. 3, the feature extraction circuitry 306, the noise control circuitry 308, and the image generation circuitry 310 implement the example generator network 100 of FIG. 1. In this example, the example feature extraction circuitry 306 extracts one or more example features from one(s) of the images in the training dataset 322 (e.g., the input image 104 of FIG. 1) to generate an example latent representation corresponding to the image(s). For example, the feature extraction circuitry 306 implements the convolutional layers 110 of the example encoder 106 of FIG. 1, and executes the convolutional layers 110 based on the input image 104. In some examples, the feature extraction circuitry 306 implements encoding techniques at the convolutional layers 110 that capture racial variations in facial features of the input image 104. In some examples, as a result of executing the convolutional layers 110, the feature extraction circuitry 306 outputs the latent representation corresponding to the input image 104, where the latent representation has a reduced spatial dimensionality but an increased feature dimensionality compared to the input image 104. In some examples, the preprocessing circuitry 304 is instantiated by programmable circuitry executing preprocessing circuitry instructions and/or configured to perform operations such as those represented by the flowchart(s) of FIGS. 4 and/or 5.

The example noise control circuitry 308 of FIG. 3 introduces noise into the latent representation output by the feature extraction circuitry 306. For example, the noise control circuitry 308 implements the one or more example residual blocks 112 of the generator network 100. In some examples, the residual blocks 112 are trained (e.g., weights of one or more convolutional layers of the residual blocks 112 are adjusted) to add noise to and/or otherwise modify the latent representation. In some examples, the noise values at the residual layers are initially (e.g., before training) randomly sampled (e.g., based on a Gaussian distribution). In some such examples, the noise values may be adjusted during one or more iterations of training of the generator network 100. In some examples, introduction of noise at the one or more residual blocks 112 enables race-specific attributes corresponding to one(s) of the racial domains to be transferred to the latent representation of the input image 104. In some examples, the noise control circuitry 308 provides the modified latent representation as input to one or more of the decoders 108 of FIG. 1. In some examples, the noise control circuitry 308 is instantiated by programmable circuitry executing noise control circuitry instructions and/or configured to perform operations such as those represented by the flowchart(s) of FIGS. 4 and/or 5.

The example image generation circuitry 310 of FIG. 3 generates one or more of the synthetic images 102 of FIG. 1 based on the modified latent representation output from the residual block(s) 112. For example, the image generation circuitry 310 implements the example decoders 108 of FIG. 1 to generate one(s) of the synthetic images 102 corresponding to respective different racial domains. In some examples, for a corresponding one of the decoders 108, the image generation circuitry 310 executes the fourth convolutional layer 114, the convolutional inverse layer 116, the fifth convolutional layer 118, and the sixth convolutional layer 120 based on the modified latent representation input to the one of the decoders 108. In some examples, as a result of executing one(s) of the layers 114, 116, 118, 120, the image generation circuitry 310 converts the latent representation to an image format and transfers style and/or race-specific characteristics from one or more reference images to the input image 104, where the reference image(s) are used during training of the generator network 100 and are representative of a racial domain associated with the one of the decoders 108. In some examples, the image generation circuitry 310 outputs one(s) of the synthetic images 102, where the synthetic images 102 include underlying content from the input image 104 modified with race-specific attributes corresponding to respective racial domains of the synthetic images 102.

In some examples, the image generation circuitry 310 generates one(s) of the synthetic images 102 for one(s) of the racial domains that are underrepresented in the training dataset 322. For example, when a number of images included the training dataset 322 for one(s) of the racial domains is less than a threshold (e.g., 500, 1000, 5000, etc.), the image generation circuitry 310 can generate the synthetic image(s) 102 for the one(s) of the racial domains. In some examples, the threshold can be the same for multiple ones of the racial domains. In some examples, respective different thresholds can be used for the racial domains. In some examples, the threshold(s) can be selected based on user input and/or based on demographic data (e.g., racial demographics associated with particular geographic region(s)). In some examples, the image generation circuitry 310 can augment the training dataset 322 by including and/or adding the generated one(s) of the synthetic images 102 to the training dataset 322. In some examples, the image generation circuitry 310 provides the synthetic image(s) 102 and/or the augmented training dataset 322 to the database 320 for storage therein. In some examples, the image generation circuitry 310 is instantiated by programmable circuitry executing image generation circuitry instructions and/or configured to perform operations such as those represented by the flowchart(s) of FIGS. 4 and/or 5.

In the illustrated example of FIG. 3, the feature extraction circuitry 306, the authenticity classification circuitry 312, and the domain classification circuitry 314 implement the example discriminator network 200 of FIG. 2. In this example, the feature extraction circuitry 306 accesses and/or obtains one or more images to be used as the input image(s) 202 to the discriminator network 200 of FIG. 2. In some examples, the input image(s) 202 can include one or more ground truth images (e.g., real and/or unmodified images) from the training dataset 322 and/or one or more of the synthetic images 102 output by the generator network 100. For example, the feature extraction circuitry 306 can access the input image 104 of FIG. 1 to be used as the first input image 202A of FIG. 2, and/or can access one of the synthetic images 102 to be used as the second input image 202B of FIG. 2. In some examples, a different number of the input images 202 and/or different combinations of the synthetic images 102 and/or ground truth images may be used instead. In some examples, the feature extraction circuitry 306 implements the first encoder layer 206A and the second encoder layer 206B of the discriminator network 200 to extract and/or encode features from the input image(s) 202. For example, the feature extraction circuitry 306 executes the first and second encoder layers 206A, 206B based on the input image(s) 202 to generate example latent representation(s) corresponding to the input image(s) 202.

The example authenticity classification circuitry 312 of FIG. 3 determines and/or predicts example authenticity classification(s) for the respective input image(s) 202. In this example, the authenticity classification circuitry 312 implements the first and second convolutional layers 212A, 212B of the example authenticity classifier 208 of FIG. 2 to determine the authenticity classification(s) (e.g., whether the respective input image(s) 202 are synthetic or ground truth images). In some examples, the authenticity classification circuitry 312 executes the first and second convolutional layers 212A, 212B based on the latent representation(s) generated by the encoder layers 206A, 206B. As a result of the execution, the authenticity classification circuitry 312 outputs the first example label(s) 204A for the respective input image(s) 202. In this example, the first label(s) 204A have values that are indicative of whether the respective input image(s) 202 are predicted (e.g., by the discriminator network 200) to be ground truth image(s) or synthetic image(s). In some examples, the first label 204A having a first value corresponding to “fake” indicates the respective one of the input images 202 is predicted to be a synthetic image. Conversely, in some examples, the first label 204A having a second value corresponding to “real” indicates the respective one of the input images 202 is predicted to be a ground truth image. In some examples, the authenticity classification circuitry 312 provides the first label(s) 204A to the database 320 to be stored therein in association with the respective input image(s) 202. In some examples, the authenticity classification circuitry 312 is instantiated by programmable circuitry executing authenticity classification circuitry instructions and/or configured to perform operations such as those represented by the flowchart(s) of FIGS. 4 and/or 5.

The example domain classification circuitry 314 of FIG. 3 determines and/or predicts example domain classification(s) for the respective input image(s) 202. In this example, the domain classification circuitry 314 implements the example convolutional layers 214A, 214B, 214C, 214D of the example domain classifier 210 of FIG. 2 to determine the domain classification(s) (e.g., the predicted racial domain for corresponding one(s) of the input images 202). In some examples, the domain classification circuitry 314 executes the convolutional layers 214A, 214B, 214C, 214D based on the latent representation(s) generated by the encoder layers 206A, 206B. As a result of the execution, the domain classification circuitry 314 outputs the second example label(s) 204B for the respective input image(s) 202. In this example, the second label(s) 204B are indicative of the predicted racial domain(s) of the respective input image(s) 202. In some examples, the domain classification circuitry 314 provides the second label(s) 204B to the database 320 to be stored therein in association with the respective input image(s) 202. In some examples, the domain classification circuitry 314 is instantiated by programmable circuitry executing domain classification circuitry instructions and/or configured to perform operations such as those represented by the flowchart(s) of FIGS. 4 and/or 5.

The example temporal analysis circuitry 316 of FIG. 3 generates example video data (e.g., synthetic video data) based on one(s) of the synthetic images 102 output by the generator network 100 of FIG. 1. For example, the temporal analysis circuitry 316 can stitch together a sequence including ones of the synthetic images 102 and/or ones of the ground truth images to generate an example synthetic video. Further, the temporal analysis circuitry 316 can perform one or more video processing techniques on video frames of the synthetic video, including frame alignment, video stabilization, noise reduction, and/or normalization of lighting conditions across ones of the video frames. In some examples, the temporal analysis circuitry 316 can augment the training dataset based on the generated synthetic video(s) and/or can provide the synthetic video(s) to the database 320 for storage therein. In some examples, the temporal analysis circuitry 316 is instantiated by programmable circuitry executing temporal analysis circuitry instructions and/or configured to perform operations such as those represented by the flowchart(s) of FIGS. 4 and/or 5.

The example training circuitry 318 of FIG. 3 generates, trains, and/or re-trains one or more machine learning models utilized by the data augmentation circuitry 300 of FIG. 3. For example, the training circuitry 318 trains one(s) of the neural networks and/or convolutional layers of the example GAN disclosed herein including the example generator network 100 of FIG. 1 and the example discriminator network 200 of FIG. 2. In the illustrated example of FIG. 3, the training circuitry 318 trains the GAN by alternating training of the generator network 100 and the discriminator network 200. For example, weights of one or more layers of the discriminator network 200 are constant and/or unchanging during training of the generator network 100 and, conversely, weights of one or more layers of the generator network 100 are constant and/or unchanging during training of the discriminator network 200. In some examples, the generator network 100 is trained for first duration, and the discriminator network 200 is trained for a second duration, where the second duration can be the same as or different from the first duration.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, machine learning models based on a Style transfer via Texture-synthesis and Arbitrary style Representation (STAR) GAN architecture and a Style GAN architecture are used. While a combined STAR and Style GAN architecture is used for the machine learning model(s) in this example, one or more different and/or architectures can be used instead. In general, machine learning models/architectures that are suitable to use in the example approaches disclosed herein will be convolutional neural networks (CNNs). However, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process. In examples disclosed herein, hyperparameters include learning rates, batch sizes, regularization terms, and/or architectural configurations.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error (e.g., based on a cross-entropy loss). As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In some examples disclosed herein, ML/AI models are trained using supervised learning. However, any other training algorithm may additionally or alternatively be used. In examples disclosed herein, training is performed until a targeted accuracy level is reached (e.g., >95%). Training is performed using hyperparameters that control how the learning is performed (e.g., a learning rate, a number of layers to be used in the machine learning model, etc.). In some examples, pre-trained model(s) are used. In some examples re-training may be performed. Such re-training may be performed in response to, for example, poor facial feature detection due to, for instance, low ambient lighting.

Training is performed using training data. In examples disclosed herein, the training data originates from reference data including images representative of human faces corresponding to different racial and/or ethnic domains. In some examples, multiple training datasets corresponding to different racial domain types can be used. For example, a first training dataset can include images representative of human faces for a first racial domain, and a second training dataset can include images representative of human faces for a second racial domain. Because supervised training is used, the training data is labeled. For example, the training data can include domain classification labels representing the predicted and/or actual (e.g., ground truth) racial domains of the corresponding images. Further, the training data can include authenticity classification labels representing whether the corresponding images are (or are predicted to be) synthetic or ground truth images.

Once training is complete, the model(s) are deployed for use as executable construct(s) that process an input and provide an output based on the network(s) of nodes and connections defined in the model(s). In examples disclosed herein, the model(s) are stored at one or more databases (e.g., the database 320 of FIG. 3). The model(s) may then be executed by the feature extraction circuitry 306, the noise control circuitry 308, the image generation circuitry 310, the authenticity classification circuitry 312, and/or the domain classification circuitry 314 of FIG. 3.

Once trained, the deployed model(s) may be operated in an inference phase to process data. In the inference phase, data to be analyzed (e.g., live data) is input to the model(s), and the model(s) execute to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model(s). Moreover, in some examples, the output data may undergo post-processing after it is generated by the AI model to transform the output into a useful result (e.g., a display of data, an instruction to be executed by a machine, etc.).

In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of updated model(s) can be triggered using the feedback and an updated training data set, hyperparameters, etc., to generate updated, deployed model(s).

Referring to FIG. 3, the training circuitry 318 trains the discriminator network 200 of FIG. 2 based on one or more ground truth images (e.g., the input image 104 of FIG. 1) and/or one or more synthetic images (e.g., the synthetic image(s) 102 of FIG. 1) output by the generator network 100. In some examples, the training circuitry 318 accesses the ground truth images and/or the synthetic images from the database 320, where the ground truth images and/or the synthetic images are labelled with ground truth labels indicating the ground truth authenticity classification(s) and/or the ground truth domain classification(s) for the corresponding image(s). Further, the training circuitry 318 obtains predicted labels (e.g., the first label(s) 204A and/or the second label(s) 204B of FIG. 2) output by the discriminator network 200 for respective ones of the ground truth images and/or the synthetic images. In some examples, the training circuitry 318 evaluates and/or executes an example discriminator loss function based on the predicted and ground truth labels to output an example discriminator loss (e.g., a discriminator loss value). In some examples, the training circuitry 318 calculates the discriminator loss based on differences between the predicted label(s) and the corresponding ground truth label(s) (e.g., whether the predicted label(s) match and/or correspond to the ground truth label(s)). In some examples, the discriminator loss function penalizes incorrect predictions and/or rewards correct predictions output by the discriminator network 200. In some examples, the training circuitry 318 updates and/or adjusts example weights of the discriminator network 200 based on backpropagation of the discriminator loss though the discriminator network 200. In some examples, the training circuitry 318 provides the trained discriminator network 200 to the database 320 for storage therein.

In the example of FIG. 3, the training circuitry 318 trains the generator network 100 of FIG. 1 based on example outputs (e.g., the predicted label(s)) from the discriminator network 200. In some examples, the training circuitry 318 can sample random noise (e.g., from a Gaussian probability distribution) to select initial weights for the generator network 100. In such examples, as a result of execution of the generator network 100 (e.g., by the feature extraction circuitry 306, the noise control circuitry 308, and/or the image generation circuitry 310 of FIG. 3), the generator network 100 outputs one(s) of the synthetic images 102 based on the sampled random noise. The discriminator network 200 of FIG. 2 outputs predicted labels (e.g., the first and second labels 204A, 204B) based on the synthetic image(s) 102. In some examples, the training circuitry 318 triggers re-training of the generator network 100 when the predicted racial domain(s) (e.g., indicated by the first label(s) 204A) do not match the ground truth domain(s) of the synthetic image(s) 102. Additionally or alternatively, the training circuitry 318 can trigger re-training of the generator network 100 when the second label(s) 204B indicate the synthetic image(s) 102 are synthetic.

In some examples, the training circuitry 318 evaluates and/or executes an example generator loss function based on the predicted and ground truth labels to output an example generator loss (e.g., a generator loss value). In some examples, the generator loss function can be the same as or different from the discriminator function used for training the discriminator network 200. In some examples, the training circuitry 318 backpropagates the generator loss through the generator network 100 and the discriminator network 200 to calculate and/or obtain example gradients therefrom. In some examples, the training circuitry 318 updates and/or adjusts the weights of the generator network 100 based on the gradients. In some examples, the training circuitry 318 provides the trained generator network 100 to the database 320 for storage therein. In some examples, the training circuitry 318 is instantiated by programmable circuitry executing training circuitry instructions and/or configured to perform operations such as those represented by the flowchart(s) of FIGS. 4 and/or 5.

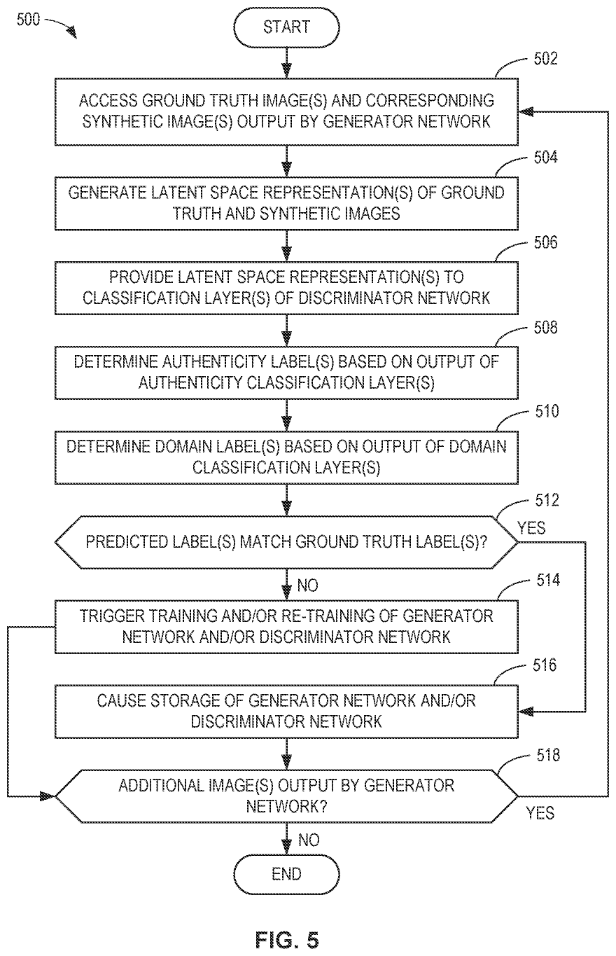

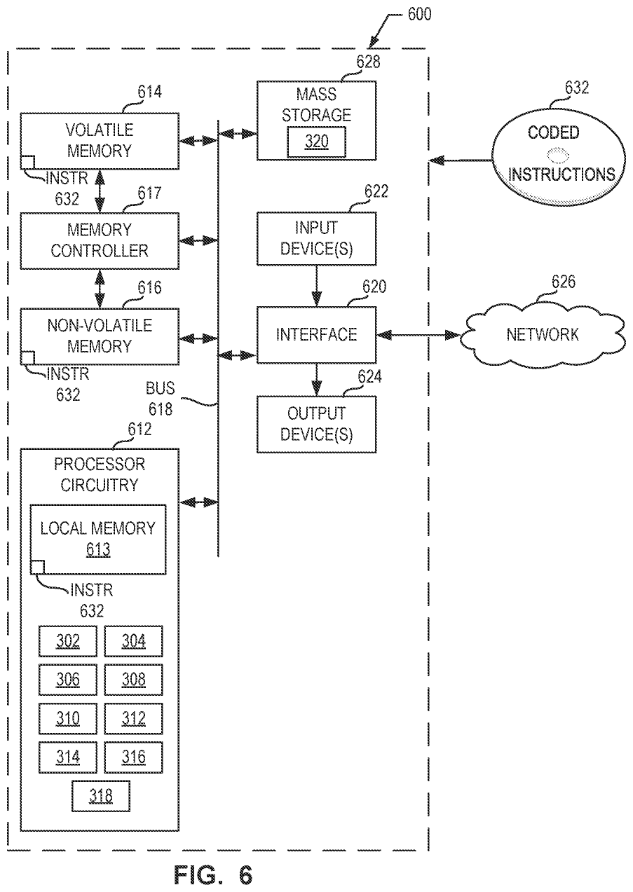

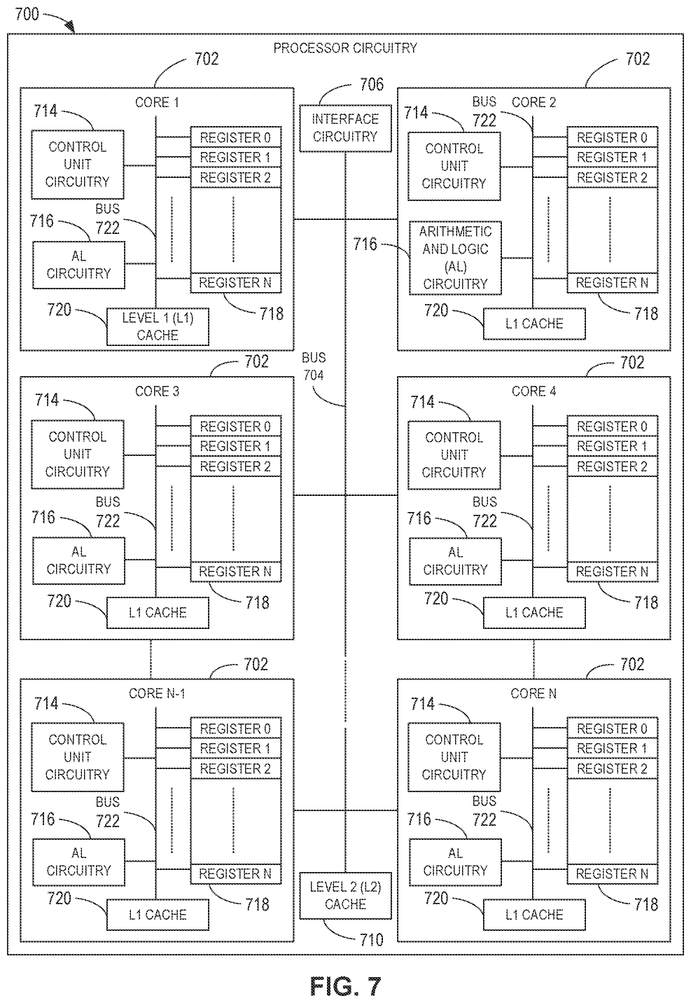

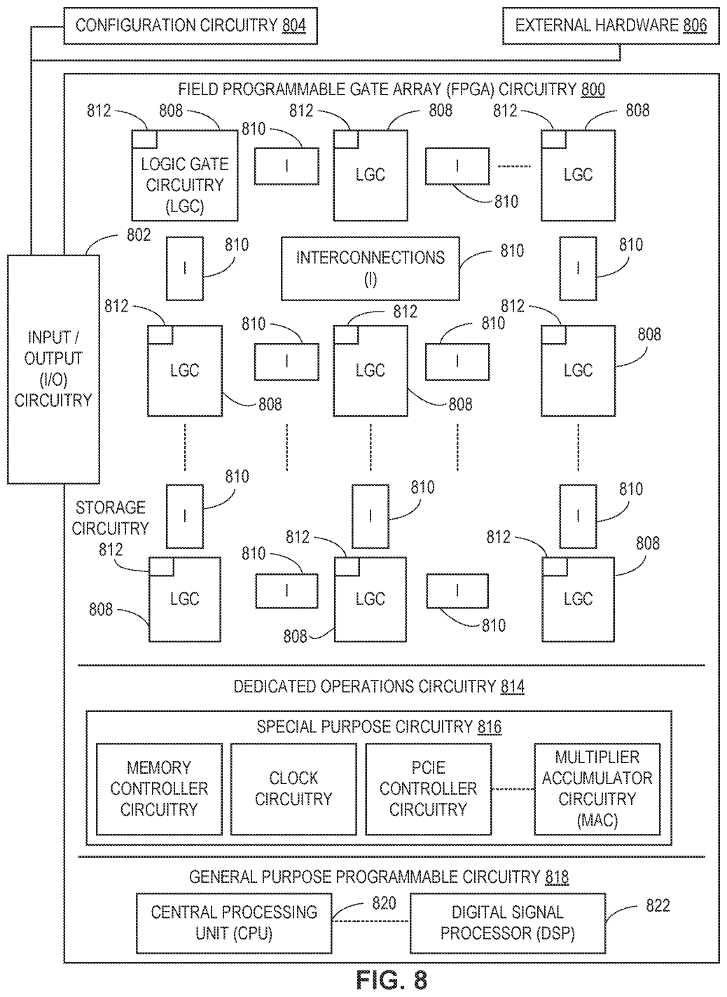

In some examples, the data augmentation circuitry 300 includes means for accessing data. For example, the means for accessing data may be implemented by the input interface circuitry 302. In some examples, the input interface circuitry 302 may be instantiated by programmable circuitry such as the example programmable circuitry 612 of FIG. 6. For instance, the input interface circuitry 302 may be instantiated by the example microprocessor 700 of FIG. 7 executing machine executable instructions such as those implemented by at least blocks 402, 418 of FIG. 4 and/or blocks 502, 518 of FIG. 5. In some examples, the input interface circuitry 302 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the input interface circuitry 302 may be instantiated by any other combination of hardware, software, and/or firmware. For example, the input interface circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the data augmentation circuitry 300 includes means for preprocessing. For example, the means for preprocessing may be implemented by the preprocessing circuitry 304. In some examples, the preprocessing circuitry 304 may be instantiated by programmable circuitry such as the example programmable circuitry 612 of FIG. 6. For instance, the preprocessing circuitry 304 may be instantiated by the example microprocessor 700 of FIG. 7 executing machine executable instructions such as those implemented by at least block 404 of FIG. 4. In some examples, the preprocessing circuitry 304 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the preprocessing circuitry 304 may be instantiated by any other combination of hardware, software, and/or firmware. For example, the preprocessing circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the data augmentation circuitry 300 includes means for extracting features. For example, the means for extracting features may be implemented by the feature extraction circuitry 306. In some examples, the feature extraction circuitry 306 may be instantiated by programmable circuitry such as the example programmable circuitry 612 of FIG. 6. For instance, the feature extraction circuitry 306 may be instantiated by the example microprocessor 700 of FIG. 7 executing machine executable instructions such as those implemented by at least block 406 of FIG. 4 and/or blocks 504, 506 of FIG. 5. In some examples, the feature extraction circuitry 306 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the feature extraction circuitry 306 may be instantiated by any other combination of hardware, software, and/or firmware. For example, the feature extraction circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the data augmentation circuitry 300 includes means for controlling noise. For example, the means for controlling noise may be implemented by the noise control circuitry 308. In some examples, the noise control circuitry 308 may be instantiated by programmable circuitry such as the example programmable circuitry 612 of FIG. 6. For instance, the noise control circuitry 308 may be instantiated by the example microprocessor 700 of FIG. 7 executing machine executable instructions such as those implemented by at least blocks 408, 410 of FIG. 4. In some examples, the noise control circuitry 308 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the noise control circuitry 308 may be instantiated by any other combination of hardware, software, and/or firmware. For example, the noise control circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the data augmentation circuitry 300 includes means for generating images. For example, the means for generating images may be implemented by the image generation circuitry 310. In some examples, the image generation circuitry 310 may be instantiated by programmable circuitry such as the example programmable circuitry 612 of FIG. 6. For instance, the image generation circuitry 310 may be instantiated by the example microprocessor 700 of FIG. 7 executing machine executable instructions such as those implemented by at least blocks 412, 414, 416 of FIG. 4. In some examples, the image generation circuitry 310 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the image generation circuitry 310 may be instantiated by any other combination of hardware, software, and/or firmware. For example, the image generation circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the data augmentation circuitry 300 includes means for generating an authenticity label. For example, the means for generating an authenticity label may be implemented by the authenticity classification circuitry 312. In some examples, the authenticity classification circuitry 312 may be instantiated by programmable circuitry such as the example programmable circuitry 612 of FIG. 6. For instance, the authenticity classification circuitry 312 may be instantiated by the example microprocessor 700 of FIG. 7 executing machine executable instructions such as those implemented by at least block 508 of FIG. 5. In some examples, the authenticity classification circuitry 312 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the authenticity classification circuitry 312 may be instantiated by any other combination of hardware, software, and/or firmware. For example, the authenticity classification circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the data augmentation circuitry 300 includes means for generating a classification label. For example, the means for generating a classification label may be implemented by the domain classification circuitry 314. In some examples, the domain classification circuitry 314 may be instantiated by programmable circuitry such as the example programmable circuitry 612 of FIG. 6. For instance, the domain classification circuitry 314 may be instantiated by the example microprocessor 700 of FIG. 7 executing machine executable instructions such as those implemented by at least block 510 of FIG. 5. In some examples, the domain classification circuitry 314 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the domain classification circuitry 314 may be instantiated by any other combination of hardware, software, and/or firmware. For example, the domain classification circuitry 314 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the data augmentation circuitry 300 includes means for generating a synthetic video. For example, the means for generating a synthetic video may be implemented by the temporal analysis circuitry 316. In some examples, the temporal analysis circuitry 316 may be instantiated by programmable circuitry such as the example programmable circuitry 612 of FIG. 6. For instance, the temporal analysis circuitry 316 may be instantiated by the example microprocessor 700 of FIG. 7 executing machine executable instructions such as those implemented by at least block 420 of FIG. 4. In some examples, the temporal analysis circuitry 316 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the temporal analysis circuitry 316 may be instantiated by any other combination of hardware, software, and/or firmware. For example, the temporal analysis circuitry 316 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the data augmentation circuitry 300 includes means for training. For example, the means for training may be implemented by the training circuitry 318. In some examples, the training circuitry 318 may be instantiated by programmable circuitry such as the example programmable circuitry 612 of FIG. 6. For instance, the training circuitry 318 may be instantiated by the example microprocessor 700 of FIG. 7 executing machine executable instructions such as those implemented by at least block 422 of FIG. 4 and/or blocks 512, 514, 516 of FIG. 5. In some examples, the training circuitry 318 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the training circuitry 318 may be instantiated by any other combination of hardware, software, and/or firmware. For example, the training circuitry 318 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the data augmentation circuitry 300 of FIG. 1 is illustrated in FIG. 3, one or more of the elements, processes, and/or devices illustrated in FIG. 3 may be combined, divided, re-arranged, omitted, eliminated, and/or implemented in any other way. Further, the example input interface circuitry 302, the example preprocessing circuitry 304, the example feature extraction circuitry 306, the example noise control circuitry 308, the example image generation circuitry 310, the example authenticity classification circuitry 312, the example domain classification circuitry 314, the example temporal analysis circuitry 316, the example training circuitry 318, the example database 320, and/or, more generally, the example data augmentation circuitry 300 of FIG. 3, may be implemented by hardware alone or by hardware in combination with software and/or firmware. Thus, for example, any of the example input interface circuitry 302, the example preprocessing circuitry 304, the example feature extraction circuitry 306, the example noise control circuitry 308, the example image generation circuitry 310, the example authenticity classification circuitry 312, the example domain classification circuitry 314, the example temporal analysis circuitry 316, the example training circuitry 318, the example database 320, and/or, more generally, the example data augmentation circuitry 300, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example data augmentation circuitry 300 of FIG. 3 may include one or more elements, processes, and/or devices in addition to, or instead of, those illustrated in FIG. 3, and/or may include more than one of any or all of the illustrated elements, processes and devices.

Flowchart(s) representative of example machine readable instructions, which may be executed by programmable circuitry to implement and/or instantiate the data augmentation circuitry 300 of FIG. 3 and/or representative of example operations which may be performed by programmable circuitry to implement and/or instantiate the data augmentation circuitry 300 of FIG. 3, are shown in FIGS. 4 and/or 5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4 and/or 5, many other methods of implementing the example data augmentation circuitry 300 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and/or 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to implement the example generator network 100 of FIG. 1. The example machine-readable instructions and/or the example operations 400 of FIG. 4 begin at block 402, at which the example data augmentation circuitry 300 of FIG. 3 accesses one or more example input images (e.g., the input image 104 of FIG. 1) representative of a first example racial domain. For example, the example input interface circuitry 302 of FIG. 3 accesses the input image 104 representative of a human face corresponding to the first racial domain.

At block 404, the example data augmentation circuitry 300 performs preprocessing of the example input image 104. For example, the example preprocessing circuitry 304 of FIG. 3 can perform one or more example preprocessing tasks on the input image 104, where the preprocessing tasks can include image alignment, normalization techniques, conversion of the input image 104 to a target format, rotating and/or scaling of the input image 104, etc.

At block 406, the example data augmentation circuitry 300 extracts example features from the input image(s) to generate an example latent representation (e.g., a latent space representation) of the input image(s). For example, the example feature extraction circuitry 306 of FIG. 3 extracts, by executing the convolutional layers 110 of the example encoder 106 of FIG. 1, the features from the input image 104 to generate the latent representation.

At block 408, the example data augmentation circuitry 300 adds noise to the latent representation at the one or more example residual blocks 112 of the generator network 100. For example, the example noise control circuitry 308 of FIG. 3 implements and/or executes one(s) of the residual blocks 112 based on the latent representation to enable race-specific attributes corresponding to one(s) of the racial domains to be transferred to the latent representation. In some examples, the noise at the residual blocks 112 can be randomly sampled, then further adjusted during one or more iterations of the training of the generator network 100.

At block 410, the example data augmentation circuitry 300 routes the latent representation to one or more decoder layers (e.g., the decoder(s) 108 of FIG. 1) corresponding to one or more target racial domains. For example, the example noise control circuitry 308 provides the latent representation to as input to one or more of the decoders 108, where the decoders 108 correspond to respective different racial domains.

At block 412, the example data augmentation circuitry 300 transfers example racial characteristics from one or more example reference images to the input image 104 (e.g., as represented by the latent representation). For example, the example image generation circuitry 310 executes the layers 114, 116, 118, 120 of corresponding one(s) of the decoders 108 based on the latent representation. In some examples, one(s) of the layers 114, 116, 118, 120 are trained to transfer the racial characteristics from the reference image(s) (e.g., corresponding to a racial domain of the one(s) of the decoders 108) to the latent representation, and/or convert the latent representation to an image format.

At block 414, the example data augmentation circuitry 300 generates and/or outputs the example synthetic image(s) 102 corresponding to the target racial domain(s). For example, as a result of executing the layers 114, 116, 118, 120 for corresponding one(s) of the decoders 108, the image generation circuitry 310 outputs the example synthetic image(s) 102 for the decoder(s) 108. In some examples, the synthetic image(s) 102 include underlying content from the input image 104, but with race-specific characteristics associated with the target racial domain(s) of the decoder(s) 108.

At block 416, the example data augmentation circuitry 300 augments an example training dataset (e.g., the training dataset 322 of FIG. 3) stored in the example database 320 with the generated synthetic image(s) 102. For example, the image generation circuitry 310 augments the training dataset 322 by including and/or adding the generated synthetic image(s) 102 to the training dataset 322 and/or by providing the synthetic image(s) 102 to the database 320 for storage therein.

At block 418, the example data augmentation circuitry 300 determines whether there are one or more additional images to analyze. For example, in response to the input interface circuitry 302 determining that there are additional image(s) to analyze (e.g., block 418 returns a result of YES), control returns to block 402. Alternatively, in response to the input interface circuitry 302 determining that there are no additional images to analyze (e.g., block 418 returns a result of NO), control proceeds to block 420.

At block 420, the example data augmentation circuitry 300 generates example synthetic video data based on the synthetic image(s) 102. For example, the example temporal analysis circuitry 316 of FIG. 3 stitches together a sequence of one(s) of the synthetic images 102 and/or one or more ground truth images (e.g., from the training dataset 322) to generate the synthetic video data. In some examples, the temporal analysis circuitry 316 performs one or more video processing techniques (e.g., frame alignment, video stabilization, noise reduction, normalization of lighting conditions, etc.) based on the synthetic video data.

At block 422, the example data augmentation circuitry 300 trains an example deepfake detection model based on the augmented training dataset 322. For example, the example training circuitry 318 can train and/or cause training of the deepfake detection model based on the augmented training dataset 322, where the trained deepfake detection model can be executed to detect synthetic images and/or video in media content.

FIG. 5 is a flowchart representative of example machine readable instructions and/or example operations 500 that may be executed, instantiated, and/or performed by programmable circuitry to implement the example discriminator network 200 of FIG. 2. The example machine-readable instructions and/or the example operations 500 of FIG. 5 begin at block 502, at which the example data augmentation circuitry 300 of FIG. 3 accesses one or more example ground truth images (e.g., the input image 104 of FIG. 1) and one or more of the corresponding synthetic images 102 output by the example generator network 100 of FIG. 1. For example, the example input interface circuitry 302 of FIG. 3 accesses the ground truth image(s) and/or the synthetic image(s) 102 from the example database 320 of FIG. 3.

At block 504, the example data augmentation circuitry 300 generates an example latent representation (e.g., a latent space representation) of the ground truth image(s) and/or the synthetic image(s). For example, the example feature extraction circuitry 306 of FIG. 3 executes the first encoder layer 206A and the second encoder layer 206B of the discriminator network 200 to extract features from the ground truth and/or synthetic image(s) and generate the example latent representation(s) thereof.

At block 506, the example data augmentation circuitry 300 provides the example latent representation(s) to one or more example classification layers of the discriminator network 200. For example, the feature extraction circuitry 306 provides the latent representation(s) as input to at least one of the example authenticity classifier 208 of FIG. 2 and/or the example domain classifier 210 of FIG. 2.

At block 508, the example data augmentation circuitry 300 determines one or more example authenticity labels (e.g., the first example label(s) 204A of FIG. 2) based on an output of the example authenticity classifier 208. For example, the example authenticity classification circuitry 312 of FIG. 3 executes the example convolutional layers 212A, 212B of the authenticity classifier 208 based on the latent representation(s). As a result of the execution, the authenticity classification circuitry 312 generates and/or outputs the first label(s) 204A for corresponding one(s) of the ground truth image(s) and/or the synthetic image(s). In some examples, the first label(s) 204A are indicative of whether the discriminator network 200 predicts the corresponding image(s) to be synthetic or ground truth images.

At block 510, the example data augmentation circuitry 300 determines one or more example domain labels (e.g., the second example label(s) 204B of FIG. 2) based on an output of the example domain classifier 210 of FIG. 2. For example, the example domain classification circuitry 314 of FIG. 3 executes the example convolutional layers 214A, 214B, 214C, 214D of the domain classifier 210 based on the latent representation(s). As a result of the execution, the domain classification circuitry 314 generates and/or outputs the second label(s) 204B for corresponding one(s) of the ground truth image(s) and/or the synthetic image(s). In some examples, the second label(s) 204B are indicative of the corresponding racial domain(s) predicted by the discriminator network 200 for the corresponding image(s).

At block 512, the example data augmentation circuitry 300 determines whether the predicted label(s) (e.g., the first label(s) 204A and/or the second label(s) 204B) match corresponding ground truth labels (e.g., ground truth authenticity label(s) and/or ground truth domain label(s)) for the synthetic image(s) and/or the ground truth image(s). For example, in response to the example training circuitry 318 of FIG. 3 determining that the predicted label(s) match the corresponding ground truth label(s) (e.g., block 512 returns a result of YES), control proceeds to block 516. Alternatively, in response to the training circuitry 318 determining that the predicted label(s) do not match the corresponding ground truth label(s) (e.g., block 512 returns a result of NO), control proceeds to block 514.

At block 514, the example data augmentation circuitry 300 triggers training and/or re-training of the example generator network 100 of FIG. 1 and/or the example discriminator network 200 of FIG. 2. For example, the training circuitry 318 can train and/or re-train the generator network 100 and/or the discriminator network 200 by calculating example loss value(s) based on the predicted and ground truth labels, and adjusting weights of the generator network 100 and/or the discriminator network 200 based on the loss value(s).

At block 516, the example data augmentation circuitry 300 causes storage of the example generator network 100 and/or the example discriminator network 200. For example, the training circuitry 318 provides the trained one(s) of the generator network 100 and/or the discriminator network 200 to the database 320 for storage therein.

At block 518, the example data augmentation circuitry 300 determines whether there are one or more additional images (e.g., additional synthetic image(s)) output by the generator network 100. In some examples, in response to the input interface circuitry 302 determining that there are additional image(s) output by the generator network 100 (e.g., block 518 returns a result of YES), control returns to block 502. Alternatively, in response to the input interface circuitry 302 determining that there are no additional image(s) output by the generator network 100 (e.g., block 518 returns a result of NO), control ends.

FIG. 6 is a block diagram of an example programmable circuitry platform 600 structured to execute and/or instantiate the example machine-readable instructions and/or the example operations of FIGS. 4 and/or 5 to implement the data augmentation circuitry 300 of FIG. 3. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example input interface circuitry 302, the example preprocessing circuitry 304, the example feature extraction circuitry 306, the example noise control circuitry 308, the example image generation circuitry 310, the example authenticity classification circuitry 312, the example domain classification circuitry 314, the example temporal analysis circuitry 316, the example training circuitry 318, and the example database 320.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 4 and/or 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4 and/or 5 to effectively instantiate the circuitry of FIG. 2 as logic circuits to perform operations corresponding to those machine readable instructions. In some such examples, the circuitry of FIG. 3 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4 and/or 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 4 and/or 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4 and/or 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4 and/or 5. As such, the FPGA circuitry 800 may be configured and/or structured to effectively instantiate some or all of the operations/functions corresponding to the machine readable instructions of the flowchart(s) of FIGS. 4 and/or 5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 4 and/or 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 4 and/or 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 4 and/or 5 to perform first operation(s)/function(s), the FPGA circuitry 800 of FIG. 8 may be configured and/or structured to perform second operation(s)/function(s) corresponding to a second portion of the machine readable instructions represented by the flowcharts of FIGS. 4 and/or 5, and/or an ASIC may be configured and/or structured to perform third operation(s)/function(s) corresponding to a third portion of the machine readable instructions represented by the flowcharts of FIGS. 4 and/or 5.

It should be understood that some or all of the circuitry of FIG. 3 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 3 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

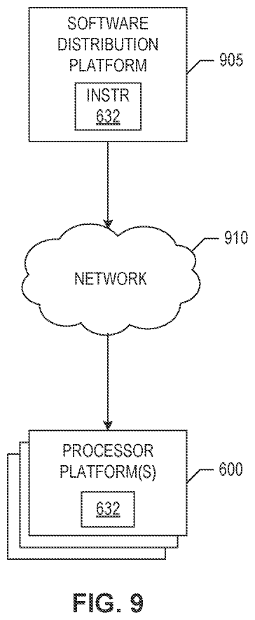

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 4 and/or 5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIGS. 4 and/or 5, may be downloaded to the example programmable circuitry platform 600, which is to execute the machine readable instructions 632 to implement the data augmentation circuitry 300. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that augment training data based on synthetic images. Examples disclosed herein generate the synthetic images based on execution of an example generative adversarial network (GAN), where the synthetic images are representative of human faces having attributes corresponding to respective different racial and/or ethnic domains. In examples disclosed herein, the synthetic images are used to augment an example training set to correct for insufficient and/or disproportionate numbers of training images for one(s) of the racial domains. By augmenting the training dataset with the synthetic image(s), examples disclosed herein may reduce bias and/or improve accuracy of a deepfake detection algorithm trained based on the training dataset. Thus, disclosed systems, apparatus, articles of manufacture, and methods improve the efficiency of using a computing device by reducing error associated with the deepfake detection algorithm. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to augment training data based on synthetic images are disclosed herein. Further examples and combinations thereof include the following:

Example 1 includes an apparatus comprising interface circuitry, instructions, and programmable circuitry to be programmed by the instructions to at least generate, with one or more first layers of a generative adversarial network (GAN), a latent representation corresponding to a first image representative of a first racial domain, generate, with one or more second layers of the GAN, a second image based on the latent representation, the second image corresponding to a second racial domain different from the first racial domain, and augment a training dataset based on the second image.

Example 2 includes the apparatus of example 1, wherein the programmable circuitry is to train a deepfake detection algorithm based on the augmented training dataset.

Example 3 includes the apparatus of example 1, wherein the one or more first layers and the one or more second layers correspond to a generator network of the GAN, and the programmable circuitry is to input the first image and the second image to a discriminator network of the GAN, the discriminator network to output at least one (a) a first label to indicate a predicted racial domain of the second image or (b) a second label to indicate whether the second image is synthetic.

Example 4 includes the apparatus of example 3, wherein the programmable circuitry is to trigger re-training of the generator network when at least one of (a) the first label indicates the predicted racial domain does not match a ground truth domain of the second image or (b) the second label indicates the second image is synthetic.

Example 5 includes the apparatus of example 1, wherein the programmable circuitry is to provide the latent representation to one or more third layers of the GAN, the one or more third layers to output a third image corresponding to a third racial domain different from the first racial domain and the second racial domain.

Example 6 includes the apparatus of example 1, wherein the programmable circuitry is to generate a synthetic video based on the second image, and augment the training dataset based on the synthetic video.

Example 7 includes the apparatus of example 1, wherein the programmable circuitry is to provide the latent representation to a plurality of residual blocks of the GAN, the plurality of residual blocks to introduce noise to the latent representation.

Example 8 includes a non-transitory computer readable medium comprising instructions to cause programmable circuitry to at least generate, with one or more first layers of a generative adversarial network (GAN), a latent representation corresponding to a first image representative of a first racial domain, generate, with one or more second layers of the GAN, a second image based on the latent representation, the second image corresponding to a second racial domain different from the first racial domain, and augment a training dataset based on the second image.

Example 9 includes the non-transitory computer readable medium of example 8, wherein the instructions are to cause the programmable circuitry to train a deepfake detection algorithm based on the augmented training dataset.

Example 10 includes the non-transitory computer readable medium of example 8, wherein the one or more first layers and the one or more second layers correspond to a generator network of the GAN, and the instructions are to cause the programmable circuitry to input the first image and the second image to a discriminator network of the GAN, the discriminator network to output at least one (a) a first label to indicate a predicted racial domain of the second image or (b) a second label to indicate whether the second image is synthetic.

Example 11 includes the non-transitory computer readable medium of example 10, wherein the instructions are to cause the programmable circuitry to trigger re-training of the generator network when at least one of (a) the first label indicates the predicted racial domain does not match a ground truth domain of the second image or (b) the second label indicates the second image is synthetic.

Example 12 includes the non-transitory computer readable medium of example 8, wherein the instructions are to cause the programmable circuitry to provide the latent representation to one or more third layers of the GAN, the one or more third layers to output a third image corresponding to a third racial domain different from the first racial domain and the second racial domain.

Example 13 includes the non-transitory computer readable medium of example 8, wherein the instructions are to cause the programmable circuitry to generate a synthetic video based on the second image, and augment the training dataset based on the synthetic video.

Example 14 includes the non-transitory computer readable medium of example 8, wherein the instructions are to cause the programmable circuitry to provide the latent representation to a plurality of residual blocks of the GAN, the plurality of residual blocks to introduce noise to the latent representation.

Example 15 includes a method comprising generating, with one or more first layers of a generative adversarial network (GAN), a latent representation corresponding to a first image representative of a first racial domain, generating, with one or more second layers of the GAN, a second image based on the latent representation, the second image corresponding to a second racial domain different from the first racial domain, and augmenting a training dataset based on the second image.

Example 16 includes the method of example 15, further including training a deepfake detection algorithm based on the augmented training dataset.

Example 17 includes the method of example 15, wherein the one or more first layers and the one or more second layers correspond to a generator network of the GAN, and further including inputting the first image and the second image to a discriminator network of the GAN, the discriminator network to output at least one (a) a first label to indicate a predicted racial domain of the second image or (b) a second label to indicate whether the second image is synthetic.

Example 18 includes the method of example 17, further including triggering re-training of the generator network when at least one of (a) the first label indicates the predicted racial domain does not match a ground truth domain of the second image or (b) the second label indicates the second image is synthetic.

Example 19 includes the method of example 15, further including providing the latent representation to one or more third layers of the GAN, the one or more third layers to output a third image corresponding to a third racial domain different from the first racial domain and the second racial domain.

Example 20 includes the method of example 15, further including generating a synthetic video based on the second image, and augmenting the training dataset based on the synthetic video.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
instructions; and
programmable circuitry to be programmed by the instructions to at least:
generate, with one or more first layers of a generative adversarial network (GAN), a latent representation corresponding to a first image representative of a first racial domain;
generate, with one or more second layers of the GAN, a second image based on the latent representation, the second image corresponding to a second racial domain different from the first racial domain; and
augment a training dataset based on the second image.

2. The apparatus of claim 1, wherein the programmable circuitry is to train a deepfake detection algorithm based on the augmented training dataset.

3. The apparatus of claim 1, wherein the one or more first layers and the one or more second layers correspond to a generator network of the GAN, and the programmable circuitry is to input the first image and the second image to a discriminator network of the GAN, the discriminator network to output at least one (a) a first label to indicate a predicted racial domain of the second image or (b) a second label to indicate whether the second image is synthetic.

4. The apparatus of claim 3, wherein the programmable circuitry is to trigger re-training of the generator network when at least one of (a) the first label indicates the predicted racial domain does not match a ground truth domain of the second image or (b) the second label indicates the second image is synthetic.

5. The apparatus of claim 1, wherein the programmable circuitry is to provide the latent representation to one or more third layers of the GAN, the one or more third layers to output a third image corresponding to a third racial domain different from the first racial domain and the second racial domain.

6. The apparatus of claim 1, wherein the programmable circuitry is to:
generate a synthetic video based on the second image; and
augment the training dataset based on the synthetic video.

7. The apparatus of claim 1, wherein the programmable circuitry is to provide the latent representation to a plurality of residual blocks of the GAN, the plurality of residual blocks to introduce noise to the latent representation.

8. A non-transitory computer readable medium comprising instructions to cause programmable circuitry to at least:
generate, with one or more first layers of a generative adversarial network (GAN), a latent representation corresponding to a first image representative of a first racial domain;
generate, with one or more second layers of the GAN, a second image based on the latent representation, the second image corresponding to a second racial domain different from the first racial domain; and
augment a training dataset based on the second image.

9. The non-transitory computer readable medium of claim 8, wherein the instructions are to cause the programmable circuitry to train a deepfake detection algorithm based on the augmented training dataset.

10. The non-transitory computer readable medium of claim 8, wherein the one or more first layers and the one or more second layers correspond to a generator network of the GAN, and the instructions are to cause the programmable circuitry to input the first image and the second image to a discriminator network of the GAN, the discriminator network to output at least one (a) a first label to indicate a predicted racial domain of the second image or (b) a second label to indicate whether the second image is synthetic.

11. The non-transitory computer readable medium of claim 10, wherein the instructions are to cause the programmable circuitry to trigger re-training of the generator network when at least one of (a) the first label indicates the predicted racial domain does not match a ground truth domain of the second image or (b) the second label indicates the second image is synthetic.

12. The non-transitory computer readable medium of claim 8, wherein the instructions are to cause the programmable circuitry to provide the latent representation to one or more third layers of the GAN, the one or more third layers to output a third image corresponding to a third racial domain different from the first racial domain and the second racial domain.

13. The non-transitory computer readable medium of claim 8, wherein the instructions are to cause the programmable circuitry to:
generate a synthetic video based on the second image; and
augment the training dataset based on the synthetic video.

14. The non-transitory computer readable medium of claim 8, wherein the instructions are to cause the programmable circuitry to provide the latent representation to a plurality of residual blocks of the GAN, the plurality of residual blocks to introduce noise to the latent representation.

15. A method comprising:
generating, with one or more first layers of a generative adversarial network (GAN), a latent representation corresponding to a first image representative of a first racial domain;
generating, with one or more second layers of the GAN, a second image based on the latent representation, the second image corresponding to a second racial domain different from the first racial domain; and
augmenting a training dataset based on the second image.

16. The method of claim 15, further including training a deepfake detection algorithm based on the augmented training dataset.

17. The method of claim 15, wherein the one or more first layers and the one or more second layers correspond to a generator network of the GAN, and further including inputting the first image and the second image to a discriminator network of the GAN, the discriminator network to output at least one (a) a first label to indicate a predicted racial domain of the second image or (b) a second label to indicate whether the second image is synthetic.

18. The method of claim 17, further including triggering re-training of the generator network when at least one of (a) the first label indicates the predicted racial domain does not match a ground truth domain of the second image or (b) the second label indicates the second image is synthetic.

19. The method of claim 15, further including providing the latent representation to one or more third layers of the GAN, the one or more third layers to output a third image corresponding to a third racial domain different from the first racial domain and the second racial domain.

20. The method of claim 15, further including:
generating a synthetic video based on the second image; and
augmenting the training dataset based on the synthetic video.
